(19) United States
(12) Patent Application Publication
(10) Pub. No.: US 2023/0236564 A1
(43) Pub. Date: Jul. 27, 2023

(54) SYSTEM AND METHOD FOR AUTOMATIC DECOMPILATION AND DETECTION OF ERRORS IN SOFTWARE

(71) Applicant: Tenable, Inc., Columbia, MD (US)

(72) Inventors: Dan SHMIDT, Tel-Aviv (IL); Segev DAGAN, Haifa (IL); Ido TRIVIZKI, Tel-Aviv (IL); David ERUKHIMOVICH, Azrikam (IL); Moria BERGMAN, Magshimim (IL)

(21) Appl. No.: 17/581,048

(22) Filed: Jan. 21, 2022

(51) Int. Cl. G05B 19/05; G06F 8/53; G06F 8/10; G06F 21/57

(52) U.S. Cl. CPC G05B 19/056; G05B 19/058; G06F 8/10; G06F 8/53; G06F 21/577; G05B 2219/163; G05B 2219/13113; G05B 2219/13118

(57) ABSTRACT

A system is disclosed for automatic retrieval and analysis of PLC code including at least one code disassembler configured to receive, via one or more passive or active scanners connected to an automation network, compiled code configured for execution on one or more devices of the automation network, the at least one code disassembler automatically disassembling the compiled code into program code. The system including an analyzing component configured to receive the program code from the code disassembler and to automatically analyze the program code for errors. The system including an alerting component configured to receive one or more detected errors from the analyzing component and to communicate or store the one or more detected errors.

### TECHNICAL FIELD

The various aspects and embodiments described herein generally relate to the automatic detection of software errors in decompiled code from an automation network.

### BACKGROUND

Identifying coding errors in a conventional software code base can involve static analysis, fault trace analysis, path testing, statement testing, or branch testing on the entire code base. That is, a conventional software code base is centrally located even after deployment. These traditional techniques and processes for analyzing program code for errors cannot be used on compiled code, especially where devices hosting and executing the code are spread throughout a network. Furthermore, in some cases the devices of the network may receive compiled code from various sources, from different vendors, and compiled from different source code languages.

The devices in an industrial automation network, a building automation network, or a power grid monitoring network are physically distributed throughout the architecture of their respective application. These distributed devices may operate on different protocols, subnets, buses, and networks. Furthermore, the configuration parameters and software for each device may be customized. Worse still, different operators or team leads may customize and update separate sections of the device network. Even if the code base is centralized, the configuration parameters and ranges for devices may be set manually on location (e.g., vent control angle). Accordingly, the conventional software analysis process cannot be performed in this distributed architecture.

Furthermore, the code transmitted or installed on the end devices is often executable code that cannot be analyzed directly. That is, the only available code may be the installed software on the end device which is in binary or machine code. The conventional software analysis process is, likewise, not adapted to handle this situation.

There is presently no system or process for collecting or separately and systematically analyzing executable code in a distributed device network. Likewise, there is presently no system or process for automatically decompiling and analyzing the code of devices in a distributed network or internet of things.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an implementation, the system includes at least one code disassembler configured to receive, via one or more passive or active scanners connected to an automation network, compiled code configured for execution on one or more devices of the automation network, the at least one code disassembler automatically disassembling the compiled code into program code, an analyzing component configured to receive the program code from the code disassembler and to automatically analyze the program code for errors, and an alerting component configured to receive one or more detected errors from the analyzing component and to communicate or store the one or more detected errors.

The one or more passive or active scanners, the at least one code disassembler, and the analyzing component may form an automated processing pipeline for analysis of the compiled code transmitted or executed within the automation network. The alerting component communicates the errors to a user of the automation network via a display. The alerting component may store the errors in a log or database along with information related to the program code, a destination address of the one or more devices receiving the compiled code, and a time stamp or version number. A passive scanner of the one or more passive or active scanners may detect packets on the automation network that include the compiled code and transmit the compiled code to a first code disassembler of the at least one code disassembler. Before transmission, the passive scanner may extract the compiled code from the packets, the compiled code being programmable logic controller (PLC) code.

The active scanner of the one or more passive or active scanners periodically retrieves the compiled code from the one or more devices of the automation network, and active scanner automatically transmits the compiled code to a first code disassembler of the at least one code disassembler. The passive scanner of the one or more passive or active scanners may automatically filter for the packets that include the compiled code and forwards the packets that include the compiled code to the first code disassembler. The errors may include security vulnerabilities that violate one or more security rules, the one or more security rules including parameter bounding requirements, parameter use requirements, or reachable code requirements. The program code includes at least one configuration of the one or more devices, such that the analyzing component may detect elements of the configuration that violate one or more security rules.

According to an implementation, the method includes receiving automatically, via one or more passive or active scanners, compiled code configured for execution on one or more devices of an automation network; disassembling automatically, via at least one code disassembler, the compiled code for the one or more devices of the automation network into program code; analyzing automatically the program code for errors via an analyzing component that receives disassembled program code from the code disassembler; and transmitting the errors in the program code of the one or more devices of the automation network to a storage component as an alert.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 is a system diagram of an automation network according to an implementation;

FIG. 2 is a system diagram of an automation network according to an implementation;

FIG. 3 is a system diagram of an automation network according to an implementation;

FIG. 4 is a system diagram of the server and various connections according to an implementation;

FIG. 5 is a process flow diagram for detecting errors in code updates to the automation network according to an implementation;

FIG. 6 is a process flow diagram for collection of code updates from field devices according to an implementation;

FIG. 7 is a process for detecting errors according to an implementation;

FIG. 8A is a system diagram of a server according to an implementation; and

FIG. 8B is a system diagram of a PLC according to an implementation.

### DETAILED DESCRIPTION OF THE DRAWINGS

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the term “asset” and variants thereof may generally refer to any suitable uniquely defined electronic object that has been identified via one or more preferably unique but possibly non-unique identifiers or identification attributes (e.g., a universally unique identifier (UUID), a Media Access Control (MAC) address, a Network BIOS (NetBIOS) name, a Fully Qualified Domain Name (FQDN), an Internet Protocol (IP) address, a tag, a CPU ID, an instance ID, a Secure Shell (SSH) key, a user-specified identifier such as a registry setting, file content, information contained in a record imported from a configuration management database (CMDB), etc.). For example, the various aspects and embodiments described herein contemplate that an asset or personal computer may be a physical electronic object such as, without limitation, a desktop computer, a laptop computer, a server, a storage device, a network device, a phone, a tablet, a wearable device, an Internet of Things (IoT) device, a set-top box or media player, etc. Furthermore, the various aspects and embodiments described herein contemplate that an asset may be a virtual electronic object such as, without limitation, a cloud instance, a virtual machine instance, a container, etc., a web application that can be addressed via a Uniform Resource Identifier (URI) or Uniform Resource Locator (URL), and/or any suitable combination thereof. Those skilled in the art will appreciate that the above-mentioned examples are not intended to be limiting but instead are intended to illustrate the ever-evolving types of resources that can be present in a modern computer network. As such, the various aspects and embodiments to be described in further detail below may include various techniques to manage network vulnerabilities according to an asset-based (rather than host-based) approach, whereby the various aspects and embodiments described herein contemplate that a particular asset can have multiple unique identifiers (e.g., a UUID and a MAC address) and that a particular asset can have multiples of a given unique identifier (e.g., a device with multiple network interface cards (NICs) may have multiple unique MAC addresses). Furthermore, as will be described in further detail below, the various aspects and embodiments described herein contemplate that a particular asset can have one or more dynamic identifiers that can change over time (e.g., an IP address) and that different assets may share a non-unique identifier (e.g., an IP address can be assigned to a first asset at a first time and assigned to a second asset at a second time). Accordingly, the identifiers or identification attributes used to define a given asset may vary with respect to uniqueness and the probability of multiple occurrences, which may be taken into consideration in reconciling the particular asset to which a given data item refers. Furthermore, in the elastic licensing model described herein, an asset may be counted as a single unit of measurement for licensing purposes.

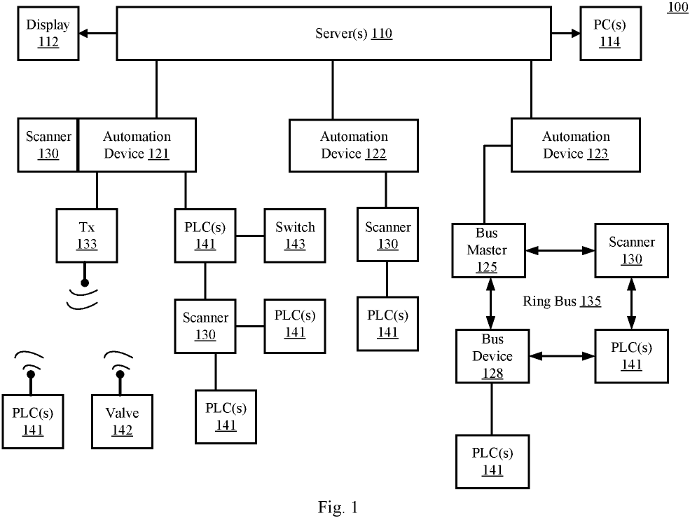

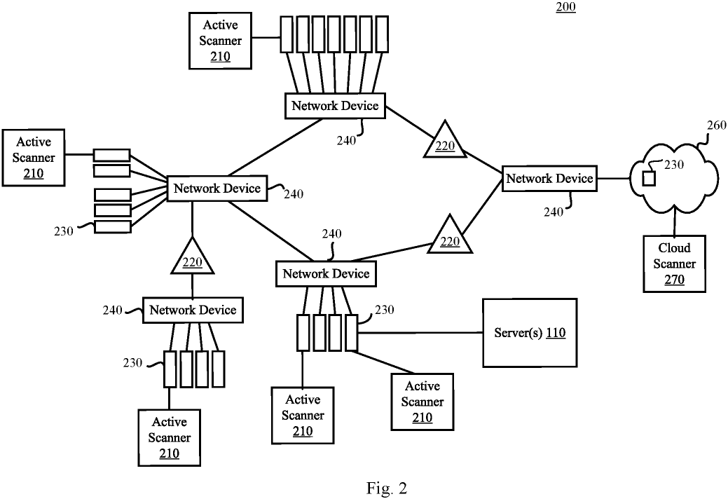

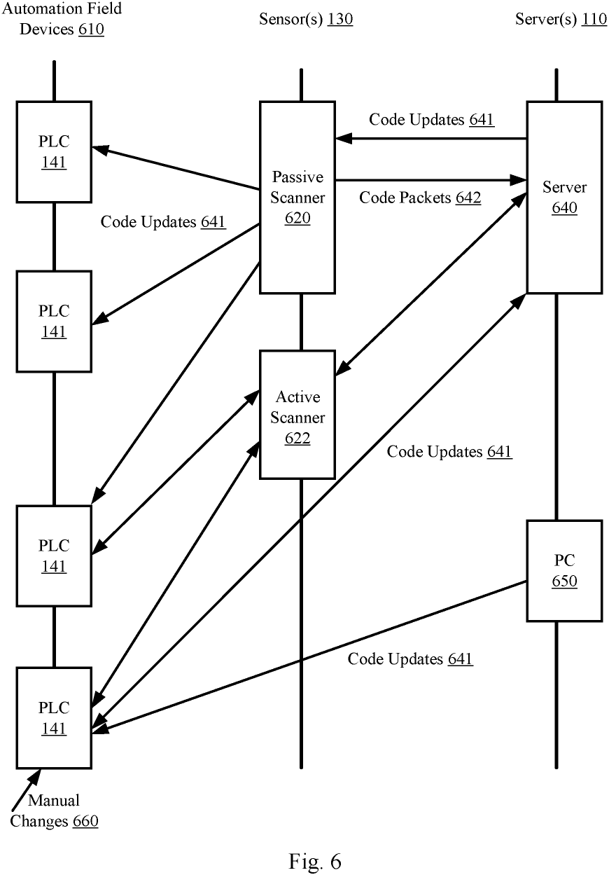

According to various aspects, FIG. 1 illustrates an exemplary automation network 100 which may be implemented in an automated building, an industrial plant, a power grid, or other distributed architecture. The servers 110 may perform a number of functions including collecting data logs from devices of the automation network 100, providing a platform for system configuration of the automation network, providing process control for the automation network, and providing high-level computing power for the automation network. The servers 110 as implemented for collection of code and detection of code errors is illustrated in more detail in FIG. 2. The hardware of servers 110 of FIG. 1 is illustrated according to an implementation in more detail in FIG. 6. The servers 110 may connect to a display 112, one or more personal computers (PC) 114, or other input mechanisms (e.g., mouse, keyboard, remote terminals, etc.) and output mechanisms (e.g., displays, personal devices, back-up storage, remote terminals, etc.).

Within the automation network 100, automation devices 121, 122, and 123 may connect to the servers 110 and may host or manage one or more networks of devices implementing the automation. The various automation devices 121, 122, and 123 may also be programmable logic controllers (PLCs), the central computing module of a PLC backplane, or other central resource. The various automation devices 121, 122, and 123 may operate on different protocols such as DeviceNet, Controller Area Network (CAN) bus, Profibus, HART, BACnet, Codesys, Modnet, and Profinet, and may operate over different communication lines including ethernet, WiFi, Universal Serial Bus (USB), protocol specific wiring/backplanes, or a combination thereof. The connections between the servers 110 and the automation devices 121, 122, and 123 may different from the communication protocol and hardware of the respective automation device’s subnet and may be TCP/IP, IEEE 802.11 or another protocol.

The PLCs 141 disposed at the nodes or field end of the respective automation subnets may control robotic arms, valves, switches, actuators, or other electromechanical devices via logic stored onboard (embedded) and executed at the respective PLC. That is, some or all of the code (e.g., executable, machine code, or source code) for operating the automated system controlled by the automation network may be disposed at distributed PLCs 141 at the ends of the subnets. The PLCs 141 may connect to one or more actuators or environment sensors in various topographies. The PLCs 141 may each have different calibration points, connection configurations, tolerances, and other configurations. For example, a PLC 141 may connect to switch 143 or a PLC 141 may connect via wireless transmitter 133 to an automation device 121 and connect to a valve 142. This embedded software and configuration data needs to be checked or monitored for errors.

In the local area network (LAN) or subnet under automation device 123, a bus master 125 connects to the automation device 123 and manages a ring bus 135 with bus device 128, PLC(s) 141, and a scanner 130, the bus device 128 may connect to a further PLC 141. The ring bus 135 may be structured as a backplane and the automation device 123 or the bus master 125 may operate as the central computer for the backplane. Bus device 125 may be a data bus subscriber, I/O module, or a router. Automation devices (e.g., automation device 121 and automation device 122) may connect and operate as translation hubs between protocols.

In each subnet, at least one scanner 130 is provided for retrieving or obtaining the compiled code that is sent over the local subnet to the PLCs 141. The scanner 130 may connect directly to an automation device 121 or may be inserted into a connection to a field device (e.g. between automation device 122 and PLC 141) or may be inserted into a ring bus 135. The connection type and placement of the scanner 130 into the hierarchy of the subnet may depend on the signaling type of the network. For example, in a broadcast-all subnet, the scanner 130 may be placed anywhere. Likewise, with a ring bus network, signals/packets travel the full loop through devices on the ring bus and so the scanner 130 may be placed anywhere in the loop. In hierarchical networks such as ethernet LANs, scanners 130 may be placed along major communication lines so as to capture the most packet traffic. The scanners 130 may be active or passive, where active scanners issue requests for compiled code from PLCs 141 and passive scanners filter or select packets from communication lines of the network that contain code in transit to PLCs 141.

The automation network 100 of FIG. 1 may transmit updates from the servers 110 to the respective automation devices and then on to the respective field devices (e.g., PLCs 141). The source of updates is described in more detail with respect to FIG. 6 below. These updates may be contained in packets transmitted along communication lines of the network and through scanners 130. The updates may contain executable or compiled computer code for the end device or any other device of the automation network 100 such that the compiled code may be used or executed upon receipt by the intended recipient. These updates may be patches, configuration changes, set points, firmware, or other software elements. Other data may be transmitted via packets to PLCs 141 from the servers 110 and from the servers 110 to the PLCs 141, as the case may be.

The scanners 130 may be passive scanners such that packets passing through the passive scanner or the adjoining or connected communication line are scanned and forwarded. Any packets containing code or configurations or the like may be copied and forwarded to the servers 110 for processing. Packets may be selected by a passive scanner based on criteria including header information, addresses, packet types, and other information in the packet. The scanners 130 may be active scanners such that PLCs 141 and other devices on the network are instructed or messaged to transmit current control software or configurations. In either case, the code retrieved or obtained by the scanners 130 may be compiled code or machine code that cannot be readily examined or analyzed.

In FIG. 2 another automation network topography is illustrated having various assets 230 that are interconnected via one or more network devices 240 and in communication with servers 110. The assets 230 may include various types, including traditional assets (e.g., physical desktop computers, servers, storage devices, etc.), web applications that run self-supporting code, Internet of Things (IoT) devices (e.g., consumer appliances, conference room utilities, cars parked in office lots, physical security systems, etc.), mobile or bring-your-own-device (BYOD) resources (e.g., laptop computers, mobile phones, tablets, wearables, etc.), virtual objects (e.g., containers and/or virtual machine instances that are hosted within the network 200, cloud instances hosted in off-site server environments, etc.), and automation field devices (e.g., PLCs, programmable switches, connected hardware, environment sensors, etc.). Those skilled in the art will appreciate that the assets 230 listed above are intended to be exemplary only and that the assets 230 associated with the network 200 may include any suitable combination of the above-listed asset types and/or other suitable asset types. Furthermore, in various embodiments, the one or more network devices 240 may include wired and/or wireless access points, small cell base stations, network routers, hubs, spanned switch ports, network taps, bus masters, backplane control modules, choke points, and so on, wherein the network devices 240 may also be included among the assets 230 despite being labelled with a different reference numeral in FIG. 2.

According to various aspects, the assets 230 that make up the network 200 (including the network devices 240 and any assets 230 such as cloud instances that are hosted in an off-site server environment or other remote network 260) may be a source for executable code to be introduced to the automation network 200. As will be apparent to those skilled in the art, the diverse nature of the various assets 230 make the network 200 substantially dynamic and without clear boundaries, whereby updates to software and configurations may be installed on automation devices or assets without informing a central repository or central production server. For example, due at least in part to exposure to the interconnectedness of new types of assets 230 and abundant software changes and updates, traditional assets like physical desktop computers, servers, and storage devices as well as basic assets like logic controllers and switches may not be centrally controlled. Although enabling customization and calibration at all levels of the automation network 200 provides efficiency and flexibility, these customizations may have flaws in the underlying code that could expose the automation network 200 to an attack, faults, or failure. In other examples, IoT devices are growing in popularity and address modern needs for connectivity but can also add scale and complexity to the network 200. Further still, as organizations adopt DevOps practices to deliver applications and services faster, software version lifetimes are reduced and short-lived assets like containers and virtual machine instances are used. Even the traditional idea of a perimeter for the automation network 200 is outdated, as many organizations are connected to cloud software that are hosted in off-site server environments.

Accordingly, to address the various security challenges that may arise due to the network 200 having a software and hardware footprint that is substantially elastic, dynamic, and without boundaries, the automation network 200 may include various components that are configured to help detect and flag software errors in the automation network 200. More particularly, the automation network 200 may include one or more active scanners 210 configured to communicate packets or other messages within the automation network 200 to retrieve new or changed information describing the various network devices 240 and other assets 230 in the automation network 200.

For example, in one implementation, the active scanners 210 may perform credentialed audits or uncredentialed scans to scan certain assets 230 in the network 200 and obtain information regarding software in use or configurations of the assets 230. More particularly, in one implementation, the credentialed audits may include the active scanners 210 using suitable authentication technologies to log into and obtain local access to the assets 230 and perform code back ups, firmware readouts, configuration queries, and the like. Alternatively and/or additionally, the active scanners 210 may include one or more agents (e.g., lightweight programs) locally installed on a suitable asset 230 and given sufficient privileges to collect updates to the code base, configuration data, and system data to be reported back to the servers 110. As such, the credentialed audits performed with the active scanners 210 may generally be used to obtain highly accurate host-based data that includes various client-side issues (e.g., recent patches, operating system settings, device parameters, etc.). On the other hand, the uncredentialed audits may generally include network-based scans that involve communicating packets or messages to the appropriate asset(s) 230 and receiving responses such as configuration profile. Furthermore, as shown in FIG. 2, one or more cloud scanners 270 may be configured to perform a substantially similar function as the active scanners 210, except that the cloud scanners 270 may also have the ability to scan assets 230 like cloud applications and machines that are hosted in a remote network 260 (e.g., an off-site server environment or other suitable cloud infrastructure).

Additionally, in various implementations, one or more passive scanners 220 may be deployed within the automation network 200 to observe or otherwise listen to traffic in the automation network 200, to identify code-containing packets transmitted over the automation network 200. In one implementation, as noted above, the active scanners 210 may obtain local access to one or more of the assets 230 or subnets in the automation network 200 (e.g., in a credentialed audit) and/or communicate various packets or other messages within the network 100 to illicit responses from one or more of the assets 230 (e.g., in an uncredentialed scan). In contrast, the passive scanners 220 may generally observe (or “sniff”) various packets or other messages in the traffic traversing the automation network 200. In particular, the passive scanners 220 may reconstruct one or more code updates from information contained in the sniffed traffic. For example, in one implementation, the reconstructed code update is acquired from a series of packets that share header information (e.g., links, addresses, etc.) and saved as a code block on the passive sensor 220 much like the code block would be saved before install on a destination PLC 141. In one implementation, the passive scanners 220 may further filter using various signatures to identify code packets and forward directly to the servers 110 without grouping. In one implementation, the passive scanners 220 may observe the network traffic continuously, at periodic intervals, on a preconfigured schedule, or in response to determining that certain criteria or conditions have been satisfied.

In one implementation, as noted above, the passive scanners 220 may generally observe the traffic traveling across the automation network 200 to reconstruct the code base of the field devices on the network, which may then be analyzed to identify potential programming errors and bugs. Accordingly, the passive scanners 220 may monitor the automation network 200 in substantially real-time to detect any potential software errors in the automation network 200 from the packets being sent over the network. Furthermore, in one implementation, the passive scanners 220 may ignore code packets and data requested by active scanners 210 and addressed to an active scanner 210 to avoid duplication. In one implementation, the passive scanners 120 may observe as many network devices 240 as possible to provide optimal visibility into the automation network 200 and the activity that occurs therein. For example, in one implementation, the passive scanners 220 may be deployed at any suitable location that enables the passive scanners 220 to observe traffic going into and/or out of one or more of the network devices 240 or one or more of the automation devices 121-123. In one implementation, the passive scanners 220 may be deployed as software or firmware on any suitable asset 230 in the network 200 that runs a suitable operating system. Each of the passive scanners 220 may connect to the servers 110 and transmit all collected code and configurations to the servers 110.

Furthermore, in one implementation, the various assets and vulnerabilities in the automation network 200 may be managed using the servers 110, which may provide a unified software update source for the various assets 230 that make up the network 200. In any case, software updates and even hardware replacement will result in a discrepancies between the code base collected by the servers 110 and the actual implemented code base. In particular, the servers 110 may aggregate the information obtained from the active scanners 110 and the passive scanners 120 to build or update the existing code base and check for these discrepancies. As such, the servers 110 may provide a unified interface to capture the code base being used throughout the automation network 200.

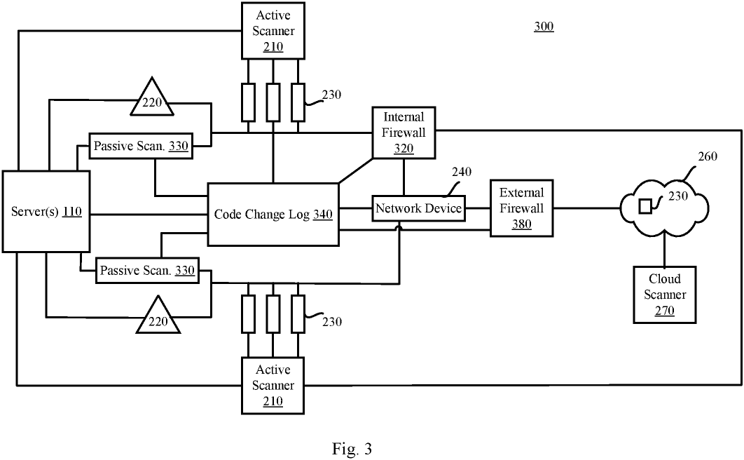

According to various aspects, FIG. 3 illustrates another exemplary network 300 with various assets 230 that connect to servers 110 for updates. In particular, the network 300 shown in FIG. 3 may have various components and perform substantially similar functionality as described above with respect to the automation networks 100/200 shown in FIGS. 1 and 2. For example, in one implementation, the automation network 300 may include one or more active scanners 210 and/or cloud scanners 270, which may interrogate assets 230 in the network 300 to build a snapshot of the code base of the assets 230, one or more passive scanners 220 that can passively observe traffic in the network 300 to further build the snapshot. Additionally, in one implementation, a code change log 340 may be arranged to receive and record updates to code and organize the compiled or executable code based on the destination or the intended asset 230. For example, in one implementation, the compiled code received and aggregated at the code change log 340 may be intended for internal firewalls 320, external firewalls 380, network devices 240, assets 230 (e.g., PLCs 141), operating systems, applications, or any other suitable resource in the network 300. Accordingly, in one implementation, the information obtained from the active scanners 210, the cloud scanners 270, the passive scanners 220, and the code change log 340 may be provided to the servers 110 to generate or update a comprehensive code base of the automation network 300 in program code (after being decompiled by the servers 110).

In one implementation, the active scanners 210 may be strategically distributed in locations across the automation network 300 to reduce stress on the network 300. For example, the active scanners 210 may be distributed at different locations in the network 300 in order to scan certain portions of the network 300 in parallel, whereby an amount of time to perform the active scans may be reduced. Furthermore, in one implementation, one or more of the active scanners 210 may be distributed at a location that provides visibility into portions of a remote network 260 and/or offloads scanning functionality from the managed network 300. For example, as shown in FIG. 3, one or more cloud scanners 270 may be distributed at a location in communication with the remote network 260, wherein the term “remote network” as used herein may refer to the Internet, a partner network, a wide area network, a cloud infrastructure, and/or any other suitable external network. As such, the terms “remote network,” “external network,” “partner network,” and “Internet” may all be used interchangeably to suitably refer to one or more networks other than the automation networks 100, 200, 300. References to “the automation network” and/or “the internal network” may generally refer to the areas that the systems and methods described herein may be used to protect or otherwise manage. Accordingly, in one implementation, limiting the portions in the managed network 300 and/or the remote network 260 that the active scanners 210 are configured to interrogate, probe, or otherwise scan and having the active scanners 210 perform the scans in parallel may reduce the amount of time that the active scans consume because the active scanners 210 can be distributed closer to scanning targets. In particular, because the active scanners 210 may scan limited portions of the network 300 and/or offload scanning responsibility to the cloud scanners 270, and because the parallel active scans may obtain information from the different portions of the network 300, the overall amount of time that the active scans consume may substantially correspond to the amount of time associated with one active scan.

As such, in one implementation, the active scanners 210 and/or cloud scanners 270 may generally scan the respective portions of the automation network 300 to obtain information describing vulnerabilities and assets in the respective portions of the automation network 300. For example, the active scanners 210 and/or cloud scanners 270 may conduct the active probes to obtain a snapshot of software code being used by devices in the network 300 at a particular point in time (e.g., actively running network devices 240, internal firewalls 280, external firewalls 284, and/or other assets 230). In various embodiments, the snapshot may further include any configurations for the actively running assets (e.g., operating systems that the assets run, whether certain policies are in place), or any other information suitably characterizing the software of assets 230 actively detected in the network 300. In one implementation, in response to obtaining the software snapshot, the active scanners 210 and/or cloud scanners 270 may then report the information from the snapshot to the servers 110, which may use the information provided by the active scanners 210 to flag software issues and errors.

Furthermore, in one implementation, the passive scanners 220 may be distributed at various locations in the network 300 to monitor traffic traveling across the network 300, traffic originating within the network 300 and directed to the remote network 260, and traffic originating from the remote network 260 and directed to the network 300, thereby supplementing the information obtained with the active scanners 210. For example, in one implementation, the passive scanners 220 may monitor the traffic traveling across the network 300 and the traffic originating from and/or directed to the remote network 260 to extract code samples or information that the active scanners 210 may be unable to obtain because the traffic may be associated with previously inactive assets that later are updated in order to be added to the automation network 300. Additionally, in one implementation, the passive scanners 220 may be deployed directly within or adjacent to a passive scanner 330, which may provide the passive scanners 220 with visibility relating multiple subnets or network devices 240 and related devices. That is, passive scanners 330 may connect to multiple protocols so as to collect and compare software updates transmitted to various subnets, network devices/routers 240, and their devices.

Accordingly, in various implementations, the passive scanners 330 may sniff one or more packets or other messages in the traffic traveling across, originating from, or directed to the network 300 to identify new network devices 240, internal firewalls 320, external firewalls 380, or other assets 230 in addition to configurations and software. The passive scanners 330 may then pass on the new device information to the active scanners 210 so that the code bases of the new devices can be scanned, probed, or requested. In addition, the passive scanners 330 may further monitor the packets in the traffic to obtain information on software updates, configurations, or parameters. In one implementation, the information that the passive scanners 220/330 obtains from sniffing the traffic traveling across, originating from, or directed to the automation network 300 may therefore provide a real-time record describing the code base at a given time, which can be logged in the code change log 340. The passive scanners 220/330 may then report the information obtained from the traffic monitored in the network to the servers 110, which may use the information provided by the passive scanners 220/330 in combination with the information provided from the active scanners 210 to alert developers of errors in software for one or more devices of the automation network 300.

In one implementation, the logged software updates and configuration changes received at the code change log 340 may include update events generated by one or more of the internal firewalls 320, external firewalls 380, network devices 240, and/or other assets 230 in the automation network 300. In one implementation, the code change log 340 may normalize the software contained in the various logs received from the sources distributed across the network 300, and in one implementation, may further aggregate the normalized events with information describing the software snapshot of the network 300 obtained by the active scanners 210 and/or the network traffic observed by the passive scanners 220/330. Accordingly, in one implementation, the code change log 340 may analyze and correlate the update events contained in the compiled code change logs, the information describing the observed network traffic, and/or the information describing the snapshot of the network 200 to automatically detect statistical anomalies, correlate errors, search the correlated software for information meeting certain criteria, or otherwise search for correlations in the compiled code logs and software update event logs.

Furthermore, in one implementation, the code change log 340 may filter the software packets, configurations, and/or the information describing the snapshot of the network 200 to reduce by de-duplication the information that the code change log 340 normalizes, analyzes, and correlates. Alternatively (or additionally), the code change log 340 may persistently save the update events and related software contained in all of the logs to comply with regulatory requirements providing that all logs must be stored for a certain period of time. As such, the code change log 340 may aggregate, normalize, analyze, and correlate information received in various event logs, software snapshots obtained by the active scanners 210 and/or cloud scanners 270, and/or the software update activity observed by the passive scanners 220 to comprehensively collect the software that makes up devices on the network. Additionally, in one implementation, the code change log 340 may be configured to report information and statistics related to the logs to the servers 110 for further analysis.

Accordingly, in various embodiments, the active scanners 210 and/or cloud scanners 270 may interrogate any suitable asset 230 in the automation network 300 to obtain information describing a software snapshot of the network 300 at any particular point in time, the passive scanners 220 may continuously or periodically observe traffic traveling in the network 300 to identify software errors or other information that further describes code base of the network 300. The servers 110 may therefore provide a unified location that aggregates asset information obtained by the active scanners 210, the cloud scanners 270, the passive scanners 220, and the code change log 340 to comprehensively build a database of the software executed or installed on the network 300.

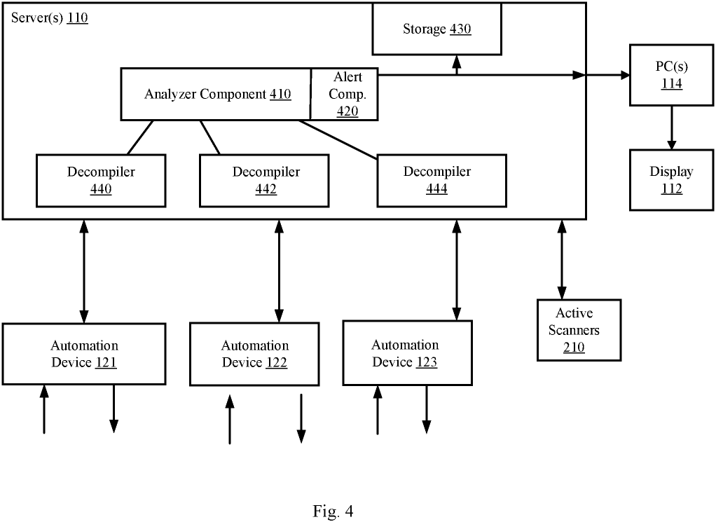

In the implementation of FIG. 4, various hardware and/or software components of the servers 110 are illustrated that operate as a system for decompiling and analyzing the executable software collected by the scanners 130, 210, and 220 of an automation network 100, 200, or 300. The automation devices 121, 122, and 123 and active scanners 210 are illustrated as connecting to the servers 110. Specifically, the servers 110 may provide software updates to PLCs and automation devices 121-123 based on automated scripts, user input or other triggers. The automation devices 121-123 may communicate these software updates to their respective subnets and may also receive code changes detected by passive scanners 220. These code changes or configuration changes from the passive scanners 220 (or code change log 340) may be forwarded on to an appropriate decompiler for re-assembly of the program code in the detected executable.

An executable code package, patch, or update may be encoded in binary or machine code for easy installation and execution at the field device (e.g., PLC 141, switch 143). The executable code has been compiled from a higher level (more human readable) computer language such as Ladder Diagram, Function Block Diagram, Structured Text, Sequential Function Charts, Instruction List, or the like into the machine-readable code. In order for the servers 110 to analyze the captured executable code, the compiled code may be de-compiled or re-assembled back into the original program language. To accomplish this, the compiled code may require a decompiler that is constructed for the original program language. Thus, decompiler 440 may decompile to certain programming languages such as IEC 61131-3 PLC programming languages (e.g., ST, FBD, LD, IL, SFC and CFC), decompiler 442 may decompile other programming languages, and decompiler 444 may decompile still further programming languages. Even though the compiled code input to each of the decompilers 440-444 may be binary, the servers 110 may need to select the correct decompiler for the end program language. In many cases, the protocol of the respective automation device 121-123, its subnet, or the PLC 141 may identify the language and decompiler required for de-compilation of the captured code. In other cases, the analyzer component 410 may decompile headers and other file information from the combined, captured packets of a software update to determine the appropriate language and decompiler to which the code should be sent. In any case, the syntax structure and logic of the original program code may be reconstructed for analysis.

The decompilers 440-444 may automatically receive compiled code packages once the servers 110 or the code change log 340 have extracted and combined the code from the captured packets. The decompilers 440-444 may automatically receive compiled code packages directly from active scanners 210 where the code package is retrieved altogether from the field device in response to a request from the active scanner 210. The decompilers 440-444 then output program code in files to the analyzer component 410. These output files may include device information so that program code files from different PLCs 141 of the same type can be differentiated. The output files or decompiled program code files may be associated with metadata collected by the scanners or included with the packets (e.g., destination addresses, headers, protocol layers, etc.). As understood to one of skill in the art, the de-compliers 440-444 may output program code that is substantially the same as the program code input to the original compiler. Deviations in white space, comments, etc. may exist but do not prevent or alter the static analysis and dynamic analysis of the decompiled program code for errors as described below. The decompilers 440-444 may be implemented as a single decompiler with internal functions to identify and decompile code of different languages.

The analyzing component 410 may be composed of one or more subcomponents and may be formed of hardware or software, or a combination thereof. The analyzer component 410 may include static analysis applications or modules that intake program code of a variety of computer languages and analyze the syntax, variable use/creation, passed variables, function definitions, and other code structures for errors and violations of best practices. For example, such violations may include unbound variables/parameters, undefined variables/parameters, division by zero, uncontrolled roll-over increments, and other structural and functional issues in the code that may cause a PLC or other automation device to break or cause further damage. For example, the compiled code on PLC 141 should check boundaries for parameters (/tags) that may be adjusted externally (by an operator). In case such parameters are being used and there is no boundary check in the PLC code, the alert component may alert the system administrator.

Software auditing applications may detect errors via static and dynamic analysis and may pair the results with a particular solution for that given issue. Certain software errors may share a given solution, or have solutions which are superseded or otherwise rendered unnecessary by other solutions. Furthermore, software errors in earlier versions may have been corrected in later versions or may not apply to the specific end device. Therefore, not all software errors may be of equal applicability to a particular hardware device or implementation (e.g. software errors in image sensor reading may be ignored if imager is disabled in PLC configuration). In accordance with an implementation, various “rulesets” are applied against the detected errors to de-duplicate them. As used herein, a ruleset is a set of rules that govern when a software error is to be flagged and when it is to be ignored. In an example, when a software error does not match a given ruleset it may be flagged for manual review.

The analyzer component 410 may run various tests against the code to detect runtime errors in what is called dynamic analysis. These runtime errors may include fork bombs, unclosed loops, improper memory sharing, and the like which can be just as damaging in automation scenarios as the types of errors found by static analysis. Some coding errors may be found by both static analysis and dynamic analysis. In order to perform these tests, the analyzer component 410 may access the compiled code instead and execute the compiled code in a test environment mimicking the field device. In this case, the tested code may still be decompiled in order to identify the location and reason for the runtime error.

If the analyzer component 410 detects a coding error in the program code or configurations collected by the scanners 130, the coding error may be transmitted to the alert component 420 which may evaluate the seriousness of the error, compare the error against other errors for de-duplication, or apply one or more filters to determine where the error alert should be sent. The alert component 420 may transmit one or more of the alerts to a graphical user interface (GUI) executed on personal computers (PCs) 114 and displayed on display 112. The alerts may be displayed as a real-time list of software issues present in the code base of the automation network 100, 200, 300 as the case may be. Characteristics of the error, the location of the error, the date the error was introduced and other features may be displayed as a part of the alert on the display 112. The alerts may also be transmitted via email to a user, or compiled into a report for an email to a user, or sent via text message to a user’s phone.

These alerts are advantageous, for example, where a third party engineer updates a portion of an industrial process or updates a PLC on the factory floor with binary code. This binary code would typically be inaccessible for analysis and certainly would not be de-compiled for review. In the implementation described herein, the binary code installed on the factory floor would be retrieved by a scanner 130 and automatically decompiled, automatically analyzed and logged, and any errors would be evaluated and displayed to the manager of the network for review and further action. In particular, the errors and alerts may be stored in storage 430 of the servers 110 for records of the real-time software issues which may be useful in tracing a recall, for example. The storage 430 may contain the entire code base as well as collected by the code change log 340.

The system provided by servers 110, and the alert component 420, in particular, may be configured to provide alerts in response to many different triggers including any software update to specific devices, or modifications of specific code, and other software changes. That is, the alerts may be customized or linked to various events, triggers, or errors. A user or system manager may implement these custom alerts via the display 112 and PC 114 connected to the servers 110 or any terminal with connection and authorization to the servers 110. The GUI on display 112 may also provide the surrounding program code relevant to the detected error of each alert.

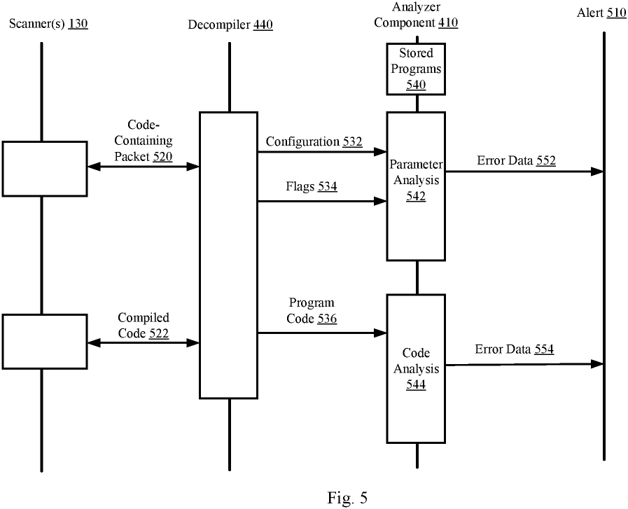

In FIG. 5 the data flow steps through the various components of FIG. 4 are described. Scanners 130 (i.e. active scanners 210, passive scanners 220/330) may filter or select packets being sent through the automation network that contain code and forward those packets to the decompiler 440 such that code-containing packets 520 are transmitted to an appropriate decompiler (matched with the computer language of the code in the packet). Likewise, scanners 130, and in particular, active scanners 210 may transmit compiled code requested from PLCs 141 to an appropriate decompiler (e.g., decompiler 440). The decompiler 440 may re-assemble the original computer language program code 536 from the received machine code and process any configuration files 532, flags 534, or parameter settings associated with the received code. All of these elements may be transmitted to the analyzer component 410. One of ordinary skill in the art will appreciate that not all configurations and flags are separated within source/program code or separate from the source/program code. The analyzer component 410 may analyze program code as written and including header files for that program code within the code analysis section 544. That is, the code analysis section 544 of the analyzer component 410 may process parameters as well. On the other hand, configurations, flags, parameters and the like that may be read or interpreted by the associated program code may be provided separately or updated separately at the PLC 141.

Where configuration files, settings, parameters, etc. are provided separately, the information is still relevant to program code function. The parameter analysis section 542 of the analyzer component 410 may compare a configuration update to past configurations or the average values of past configurations. If the configuration update differs by more than a standard deviation, threshold, or order of magnitude from past configurations, then the parameter analysis may determine that the configuration value is in error as error data 522. Likewise, the parameter analysis may record or identify the disabling of flags 534 or functions at the PLC 141 via configuration to be errors as error data 552 based on statistical analysis or rule sets. In this way, manual overrides and manual set values may be retrieved and analyzed for errors (e.g., fat finger errors) at a central analysis resource (e.g., analyzer component 410).

Likewise, the program code 536 is transmitted to the code analysis section 544 where static analysis and dynamic analysis may be performed on the program code. The static analysis may vary based on the computer language in the program code and may include assignment analysis, abstraction analysis, bitwise operation analysis, deprecated function flagging, regular expression syntax analysis, control flow analysis (e.g., unreachable code), fault/failure handling analysis, interface analysis, and data analysis. Static analysis may be considered to cover those tests and analysis performed without executing the program and directed at the source code. Static analysis may take as an input a coding standard that defines one or more rule sets and one or more best practices to check the program code 536 against (e.g., IEC 61508 and IEC 62061). If any of the input program code 536 from the decompiler 440 is determined to have an error based on the above analysis, then the alert function 510 receives the details of the error as error data 554.

The alert function 510 may operate on the alert component 420 and may receive the error data 552 and the error data 554. The alert function 510 may evaluate the importance of the identified errors, filter the errors based on local data, local standards, management overrides, or the like, and arrange relevant information into an email or graphical alert. The alert function 510 may determine that errors within error data 554 and/or errors in error data 552 and 554 are related and may display the errors as such on display 112. If the received and decompiled code fragment is less than a threshold length, the alert function 510 may retrieve surrounding code from stored programs 540. The stored programs 540 may operate as a repository on storage 430 storing code of the whole code base. The analyzer component 410 and sub-components may access this stored code for statistical analysis and comparisons. In an implementation, error data 554 may include surrounding code for a coding error in a coding fragment from a decompiled packet.

In FIG. 6, the flow of code updates to PLCs 141 from various sources is illustrated along with the methods of retrieving those code updates via scanners 130. Specifically, code updates 641 may be transmitted over communication lines of the automation network through passive scanner 620 from server 640. The code updates 641 may also be transmitted directly from the server 640 to the PLC 141; and, in some implementations, the server 640 delivering updates is a separate system or device from the servers 110 receiving compiled code and performing analysis. The code updates 641 then continue on to the PLCs 141 where they may be installed or saved. The code updates 641 may include program code and configuration changes. Code updates 641 may be sent additionally or alternatively from personal computer (PC) 650 which is controlled by a third party repair person or mobile maintenance worker, for example. Manual changes 660 may be performed to program code or configurations of the PLCs 141. In all of these cases, the server 640 may not have the full code base and certainly may not have the full code base in program code.

The passive scanner 620 may capture the packets of code updates 641 and transmit a copy of those packets or a consolidated file of the packets back to server 640 (and specifically, a decompiler). The active scanner 622 may receive an instruction from server 640 to conduct a scan on one or more PLCs 141 within its network or subnet. The scan by the active scanner 622 may involve issuing requests for code and/or configuration dumps by the PLCs 141 to the active scanner 622. These code and/or configuration dumps will capture the code updates from the PC 650 and the manual changes 660. The active scanner 622 may then transmit the captured code from the request back to the server 640. The active scanner 622 may periodically request code and configuration dumps from the PLCs 141 connected to it without instructions from the server 640. If changes in the code or configuration are identified by the active scanner 622 or the code change log 340, then these changes may be transmitted to the server 640 for analysis as code packets or code files. That is, the active scanner 622 may compare code versions or hashes of code versions for PLCs 141 in order to identify if analysis of the code is warranted. If analysis is not warranted, the active scanner 622 may not forward the dumped code to the server 640.

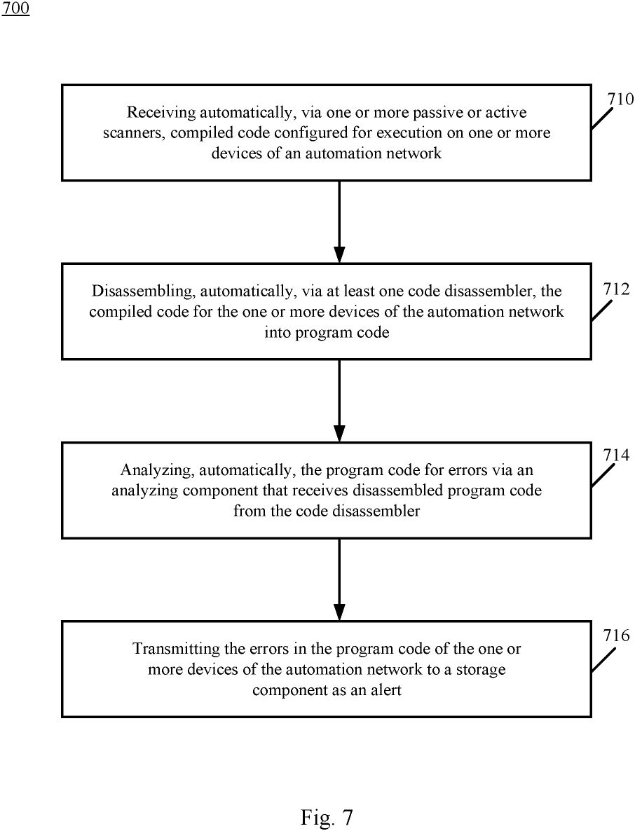

The process 700 of FIG. 7 relates to a method for automatically retrieving and analyzing PLC code and generating an alert for any errors. At 710, the process may begin by receiving automatically, via one or more passive or active scanners, compiled code configured for execution on one or more devices of an automation network. This compiled code may be received at servers 110/640 or de-compilers 440-444. At 712, the process continues by disassembling automatically, via at least one code disassembler, the compiled code for the one or more devices of the automation network into program code. This program code may be in a human-readable computer language. In programming terminology, to disassemble is to convert a program in its executable (ready-to-run) form (sometimes called object code) into a representation in some form of assembler language so that it is readable by a human. Disassemble, decompile, and re-assemble may be used herein interchangeably. As a part of the disassembly, the servers 110 may automatically select an appropriate decompiler based on an analysis of the compiled code or compiled code fragment.

At 714, the process may continue by analyzing automatically the program code for errors via an analyzing component (e.g., analyzer component 410) that receives disassembled program code from the code disassembler (e.g., decompiler 440). This analysis may include static and dynamic analysis as described above. At 716, the process 700 may continue by transmitting the errors in the program code of the one or more devices of the automation network to a storage component as an alert. The alert may also be transmitted to a display connected to the automation network so as to alert a user. The errors may include security vulnerabilities that violate one or more security rules, the one or more security rules including parameter bounding requirements, parameter use requirements, or reachable code requirements. The one or more passive or active scanners, the at least one code disassembler, and the analyzing component may form an automated processing pipeline for analysis of the compiled code transmitted or executed within the automation network.

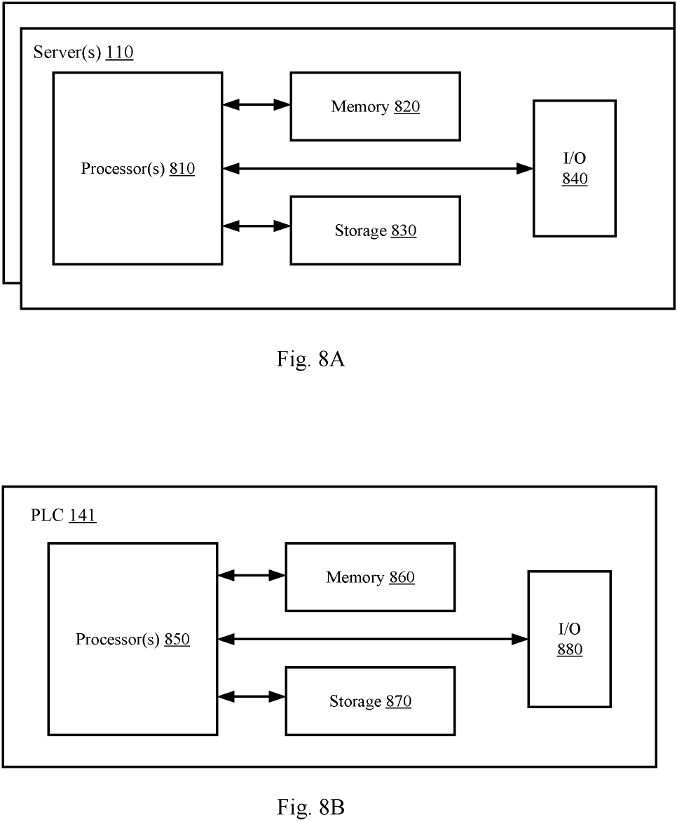

In FIG. 8A an implementation of internal server hardware for servers 110 is illustrated. In particular, servers 110 may include one or more processors 810, memory 820 (e.g., random access memory, cache, and the like), storage 830 (e.g., optical disks, hard drives, solid state drives, and the like), and input/output interfaces 840 (e.g., WiFi, USB, ethernet, fiber optic, etc.). The decompilers 440-444, the analysis component 410, and the alert component 420 may run on or be executed on processors 810 and memory 820. The storage 430 and stored programs 540 may be hosted on storage 830, such storage 830 may be supplemented with external cloud storage. The servers 110 may communicate with automation networks 100, 200, and 300 via I/O interfaces 840.

In FIG. 8B an implementation of PLC 141 is illustrated including internal hardware. The PLC 141 may include one or more processors 850 (e.g., field programmable gate arrays, application specific integrated circuits, integrated circuits, microprocessors, and the like), memory 860 (e.g., random access memory, read only memory, cache, and the like), storage 870 (e.g., flash memory, read only memory, etc.), and input/output interface 880 (e.g., ethernet, USB, a backplane bus, a serial interface, or the like). The PLC 141 may be configured via firmware or software to dump or output via I/O 880 any executable code and configurations stored on storage 870 upon request. The I/O 880 may connect to the automation networks 100, 200, 300, and automation devices 121-123. Other hardware configurations may be contemplated for the PLCs 141 as understood by one of ordinary skill in the art.

Those skilled in the art will appreciate that information and signals may be represented using any of a variety of different technologies and techniques. For example, data, instructions, transmissions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A system, comprising:
at least one code disassembler configured to receive, via one or more passive or active scanners connected to an automation network, compiled code configured for execution on one or more devices of the automation network, the at least one code disassembler automatically disassembling the compiled code into program code;
an analyzing component configured to receive the program code from the code disassembler and to automatically analyze the program code for errors; and
an alerting component configured to receive one or more detected errors from the analyzing component and to communicate or store the one or more detected errors.

2. The system of claim 1, wherein the one or more passive or active scanners, the at least one code disassembler, and the analyzing component form an automated processing pipeline for analysis of the compiled code transmitted or executed within the automation network.

3. The system of claim 1, wherein the alerting component communicates the errors to a user of the automation network via a display.

4. The system of claim 1, wherein the alerting component stores the errors in a log or database along with information related to the program code, a destination address of the one or more devices receiving the compiled code, and a time stamp or version number.

5. The system of claim 1, wherein at least one passive scanner of the one or more passive or active scanners detects packets on the automation network that include the compiled code and transmits the compiled code to a first code disassembler of the at least one code disassembler.

6. The system of claim 5, wherein, before transmission, the at least one passive scanner extracts the compiled code from the packets, the compiled code being programmable logic controller (PLC) code.

7. The system of claim 1, wherein at least one active scanner of the one or more passive or active scanners periodically retrieves the compiled code from the one or more devices of the automation network, and wherein the at least one active scanner automatically transmits the compiled code to a first code disassembler of the at least one code disassembler.

8. The system of claim 1, wherein at least one passive scanner of the one or more passive or active scanners automatically filters for the packets that include the compiled code and forwards the packets that include the compiled code to the first code disassembler.

9. The system of claim 1, wherein the errors include security vulnerabilities that violate one or more security rules, the one or more security rules including parameter bounding requirements, parameter use requirements, or reachable code requirements.

10. The system of claim 1, wherein the program code includes at least one configuration of the one or more devices, the analyzing component detecting elements of the configuration that violate one or more security rules.

11. A method, comprising:
receiving automatically, via one or more passive or active scanners, compiled code configured for execution on one or more devices of an automation network;
disassembling automatically, via at least one code disassembler, the compiled code for the one or more devices of the automation network into program code;
analyzing automatically the program code for errors via an analyzing component that receives disassembled program code from the code disassembler; and
transmitting the errors in the program code of the one or more devices of the automation network to a storage component as an alert.

12. The method of claim 11, wherein the one or more passive or active scanners, the at least one code disassembler, and the analyzing component form an automated processing pipeline for analysis of the compiled code transmitted or executed within the automation network.

13. The method of claim 11, wherein the alert communicates the errors to a user of the automation network via a display.

14. The method of claim 11, further comprising:
storing the errors in a log or a database along with information related to the program code, a destination address of the one or more devices receiving the compiled code, and a time stamp or version number.

15. The method of claim 11, wherein the compiled code is extracted from packets detected on the automation network via at least one passive scanner of the one or more passive or active scanners, and
wherein the extracted compiled code is transmitted to a first code disassembler of the at least one code disassembler.

16. The method of claim 11, further comprising:
retrieving, periodically, the compiled code from the one or more devices of the automation network via at least one active scanner of the one or more passive or active scanners periodically,
wherein the at least one active scanner automatically transmits the compiled code to a first code disassembler of the at least one code disassembler.

17. The method of claim 11, wherein at least one passive scanner of the one or more passive or active scanners automatically filters for the packets that include the compiled code and forwards the packets that include the compiled code to the first code disassembler.

18. The method of claim 11, wherein the errors include security vulnerabilities that violate one or more security rules, the one or more security rules including parameter bounding requirements, parameter use requirements, or reachable code requirements.

19. The method of claim 11, wherein the program code includes at least one configuration of the one or more devices, the analyzing component detecting elements of the configuration that violate one or more security rules.
